(19) United States
(12) Patent Application Publication
(10) Pub. No.: US 2008/0174049 A1
(43) Pub. Date: Jul. 24, 2008

(54) Apparatus and method for making a masonry block

(75) Inventors: James Hammer, University Place, WA (US); Ronald Dunn, Vancouver, WA (US)

Correspondence Address: KLARQUIST SPARKMAN, LLP, 121 SW SALMON STREET, SUITE 1600, PORTLAND, OR, 97204, US

(73) Assignee: Westblock Systems, Inc.

(21) Appl. No.: 11/825,485

(22) Filed: Jul. 6, 2007

Related U.S. Application Data
(60) Provisional application No. 60/897,027, filed on Jan. 22, 2007.

(51) Int. Cl. B28B 7/10; B28B 5/00

(52) U.S. Cl. 264/336; 264/299; 425/457; 425/470

(57) ABSTRACT

According to one aspect, the present disclosure concerns embodiments of an apparatus and method for making a wall block, such as for constructing retaining walls or fences, that has at least one surface formed with a pattern resembling the faces of multiple blocks. In particular embodiments, the surface of the wall block has a plurality of discrete surface portions that are separated by one or more elongated recessed surface portions or scores such that each surface portion resembles the face of a separate block. The surface portions can be provided with roughened surface textures resembling the surface of a split block, which can be formed by roughening or texturing the uncured block as it is removed from a mold.

### CROSS-REFERENCE TO RELATED APPLICATION

The present application claims the benefit of U.S. Provisional Application No. 60/897,027, filed Jan. 22, 2007.

### FIELD

The present disclosure concerns embodiments of an apparatus and method for making a wall block, such as for constructing retaining walls or fences.

### BACKGROUND

Masonry products, such as blocks or bricks for constructing walls, have been made for many years by various molding processes. It is common to split off a portion of a cured block, such as with a splitting machine or a hammer and chisel, so as to create a decorative face on a surface of the block that resembles the surface texture of natural stone. The face created by the splitting process is often referred to in the industry as “split face” or “rock face.” Blocks formed with a split face are highly appealing for constructing retaining walls and fences. The splitting of cured blocks, however, involves additional equipment and manufacturing steps and results in material wastage.

In order to avoid the shortcomings of conventional splitting processes, a number of techniques have been developed to achieve the same “split face” texture without additional splitting steps. For example, U.S. Pat. No. 7,100,866 to Hammer et al. discloses a mold having a series of inwardly extending projections that contact an adjacent surface of an uncured block in the mold. As the uncured block is stripped from the mold, the projections create a roughened or irregular surface texture on the adjacent block surface resembling a “split face.”

It is also desirable to create an “ashlar” or random pattern in the exposed face of a retaining wall or fence to provide the appearance of a wall made from natural stone blocks. Various block systems have been proposed to create an ashlar pattern in a wall. These block systems typically comprise multiple blocks of different sizes that can be randomly stacked together in a wall. Another technique used to form an ashlar pattern involves stamping or molding into the surface of an uncured block a pattern that resembles the faces of multiple, differently sized blocks. This allows construction of a wall having an ashlar pattern using multiple blocks of the same size and shape.

### SUMMARY

According to one aspect, the present disclosure concerns embodiments of an apparatus and method for making a wall block, such as for constructing retaining walls or fences, that has at least one surface formed with a pattern resembling the faces of multiple blocks. In particular embodiments, the surface of the wall block has a plurality of discrete surface portions that are separated by one or more elongated recessed surface portions or scores such that each surface portion resembles the face of a separate block. The surface portions can be provided with roughened surface textures resembling the surface of a split block, which can be formed by roughening or texturing the uncured block as it is removed from a mold.

According to one representative embodiment, an apparatus for molding and forming a roughened surface texture on at least one surface of an uncured masonry block, comprises a mold defining at least one mold cavity, a first opening through which block-forming material is introduced into the mold cavity, and a second opening through which a formed, uncured block may be removed from the mold cavity. The mold further comprises at least one wall having a plurality of projections extending into the mold cavity and contacting an adjacent surface of the uncured block, such that when the uncured block is removed from the mold cavity, the projections create a roughened surface texture on at least two surface portions of the adjacent surface, the at least two surface portions being separated by a recessed surface portion in the adjacent surface to give the appearance of two separate block faces in the adjacent surface.

According to another representative embodiment, an apparatus for molding and forming a roughened surface texture on at least one surface of an uncured masonry block, comprises a mold defining at least one mold cavity, in which an uncured block can be formed. The mold has an inner surface that forms an elongated notch in at least one surface of the uncured block to define first and second surface portions on opposite sides of the notch. The inner surface comprises a plurality of block-texturing members that form a roughened surface texture on the first and second surface portions when the block-texturing members are moved across the first and second surface portions upon removal of the uncured block from the mold.

According to another representative embodiment, a method for forming a masonry block, comprises introducing block-forming material into a mold cavity of a mold, the mold having a plurality of projections extending into the mold cavity and located between the top and bottom of the mold cavity. The method further includes forming an uncured block in the mold cavity, the uncured block having at least one surface on which there is formed at least one elongated recessed surface portion separating the at least one surface into first and second surface portions, and removing the uncured block from the mold cavity to move the projections across the at least one surface of the uncured block to produce a roughened texture on the first and second surface portions so as to give the appearance of two split block faces on the at least one surface of the uncured block.

According to yet another representative embodiment, a method for forming a masonry block using a mold comprising a plurality of walls, a first opening, and a second opening opposite the first opening is provided. The method comprises introducing block-forming material into the mold via the first opening to form an uncured block having at least one surface on which there is formed at least one elongated notch separating the at least one surface into first and second surface portions, and removing the uncured block from the mold through the second opening, wherein the act of removing the uncured block from the mold creates a roughened texture on the first and second surface portions to provide the appearance of two separate split block faces on the at least one surface of the uncured block.

According to another representative embodiment, a method for forming a masonry block comprises placing a core bar in a mold, the core bar having a plurality of projections formed thereon, forming an uncured block in a mold, and moving the core bar relative to the uncured block to create a roughened surface texture on a surface portion of the uncured block contacting the projections of the core bar.

According to yet another representative embodiment, a core bar comprises an elongated body having plurality of projections configured to create a roughened surface texture on a surface of an uncured masonry block as the projections are moved across the surface of the uncured block.

The foregoing and other features and advantages of the invention will become more apparent from the following detailed description, which proceeds with reference to the accompanying figures.

### BRIEF DESCRIPTION OF THE DRAWINGS

FIG. 1 is a perspective view of an exemplary embodiment of a wall block having two opposing surfaces (one of which is shown in FIG. 1), each of which is formed with three roughened surface portions giving the appearance of three separate block faces.

FIG. 2 is a front elevation view of the block of FIG. 1.

FIG. 3 is a side elevation view of the block of FIG. 1.

FIG. 4 is a top plan view of the block of FIG. 1.

FIG. 5 is a schematic, cross-sectional view of an exemplary embodiment of a mold for forming multiple blocks of the type shown in FIG. 1.

FIG. 6 is a schematic, cross-sectional view of the mold of FIG. 5 showing a plurality of formed, uncured blocks being removed from the mold.

FIG. 7 is a schematic, side elevation view of the mold shown in FIG. 5.

FIG. 8 is a schematic, top plan view of the mold shown in FIG. 5.

FIG. 9 is a front elevation view of an exemplary embodiment of a mold wall that can be used in the mold shown in FIG. 5 to form the three roughened surface portions on the surface of an uncured block formed in the mold.

FIG. 10 is a cross-section view of the mold wall taken along line 10-10 in FIG. 9.

FIG. 11 is a cross-sectional view of the mold wall taken along line 11-11 in FIG. 9.

FIG. 12 is a schematic top plan view of a mold for forming a plurality of blocks, according to another embodiment.

FIG. 13 is a perspective view of a block that can be made using the mold shown in FIG. 12.

FIG. 14 is a top plan view of the block shown in FIG. 13.

FIG. 15 is a perspective view of a core bar assembly that can be used with the mold shown in FIG. 12, according to one embodiment.

FIG. 16 is a front elevation view of the core bar assembly shown in FIG. 15.

FIG. 17 is a top plan view of the core bar assembly shown in FIG. 15.

FIG. 18 is an enlarged, perspective view of one of the core bars of the core bar assembly, as viewed from the top and two sides of the core bar.

FIG. 19 is an enlarged, fragmentary perspective view of the core bar shown in FIG. 18, as viewed from the bottom and one side thereof.

FIG. 20 is a side elevation view of the core bar shown in FIG. 18.

FIG. 21 is another side elevation view of the core bar rotated 90 degrees about the longitudinal axis of the core bar from the position shown in FIG. 20.

FIG. 22 is a top plan view of the core bar shown in FIG. 18.

FIG. 23 is a schematic, top plan view of another embodiment of a mold for making a masonry block.

FIG. 24 is a schematic, top plan view of still another embodiment of a mold for making a masonry block.

### DETAILED DESCRIPTION

As used herein, the singular forms “a,” “an,” and “the” refer to one or more than one, unless the context clearly dictates otherwise.

As used herein, the term “includes” means “comprises.” For example, a device that includes or comprises A and B contains A and B but may optionally contain C or other components other than A and B. A device that includes or comprises A or B may contain A or B or A and B, and optionally one or more other components such as C.

As used herein, the term “ashlar pattern” refers to a pattern of differently sized block faces in the exposed surface of a wall or other structure constructed from multiple masonry blocks. The embodiments disclosed herein can be adapted to produce an ashlar pattern in at least one surface of a single block, so as to give the appearance of multiple block faces of different sizes.

As used herein, the term “masonry block” refers generally to any block that can be laid or stacked with other blocks to form a structure, such as a wall, steps, or a structure providing a horizontal upper surface (e.g., a walkway or patio). A masonry block can have any geometric shape, including but not limited to a square, rectangle, trapezoid, diamond, or combinations thereof. The structures formed by masonry blocks need not utilize mortar to join adjacent blocks.

According to one aspect, the present disclosure concerns embodiments of an apparatus and method for making a masonry block having two or more roughened surface portions on the same surface of the block to provide the block the appearance of two or more split faces of multiple blocks. In particular embodiments, the roughened surface portions are different sizes to create a random, or ashlar, pattern on one surface of the block. The embodiments described herein can be adapted to produce various types of masonry blocks, such as decorative architectural blocks, paving stones, landscaping blocks, retaining wall blocks, blocks for constructing fences or free-standing walls, steps, or walkways, and the like.

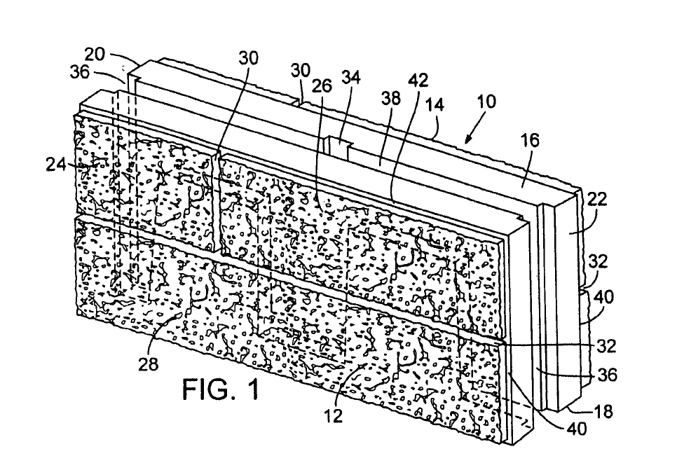

FIGS. 1-4 show an exemplary embodiment of a masonry block 10 that can be made using the apparatus and methods disclosed herein. As shown, the illustrated block 10 includes first and second faces 12 and 14, respectively, a top surface 16, a bottom surface 18, and side surfaces 20, 22 extending between the first and second faces. The block 10 in the illustrated example is adapted to be used in constructed a free-standing wall or fence having two exposed wall surfaces. When constructing a wall from multiple blocks 10, the blocks 10 are placed in courses with the first faces 12 of the blocks exposed in one surface of the wall and the second faces 14 exposed in the opposite surface of the wall. The block 10 can be formed with a centrally located, vertical core 34, vertical cores 36 at opposite sides of the block (as best shown in FIG. 4), and a horizontally extending channel, or trough, 38 opening at the sides 20, 22 and the top 16 of the block. The cores 34, 36 and channel 38 can be adapted to receive hardware for interconnecting multiple blocks in a wall, such as vertically and/or horizontal extending tensioning members or rebar.

In the illustrated embodiment, each of the first and second faces 12, 14 can be formed with first, second, and third surface portions 24, 26, and 28, respectively, a vertically extending recessed portion, or elongated notch, 30 separating the first and second surface portions 24, 26, and a horizontally extending recessed portion, or elongated notch, 32 separating the third surface portion 28 from the first and second surface portions 24, 26. The horizontal recessed portion 32 extends from one side surface 20 to the other side surface 22 so as to bisect the block face into upper and lower surface portions. The vertical recessed portion 30 extends from the top surface 16 and intersects the horizontal recessed portion 32 to separate the upper surface portion into the first and second surface portions 24, 26. By virtue of the recessed portions 30, 32 separating the faces 12, 14 into three distinct surface portions, each face 12, 14 appears to be formed from the block faces of three separate blocks. As shown, the surface portions 24, 26, 28 desirably are of different sizes to provide a random or ashlar pattern in each face of the block.

Each face 12, 14 of the block also can be formed with recessed portions, or notches or scores, 40 extending between the top and bottom surfaces 16, 18 on each side of the respective face, and formed with a recessed portion, or notch, 42 extending between the sides surfaces 20, 22 adjacent the top surface 16. When like blocks 10 are stacked side-by-side and on top of each other in multiple courses to form a wall, the recessed portion 40 of one block abuts against the recessed portion 40 of an adjacent block in the same course to form a generally U-shaped, vertically extending groove separating the face 12, 14 of one block from the face 12, 14 of the other block. For example, if blocks are laid side-by-side such that the side surface 22 of each block abuts against the side surface 20 of an adjacent block, the recessed portions 40 at the juncture of two adjacent blocks separate surface portions 26, 28 of one block from the surface portions 24, 28 of the adjacent block. Similarly, the horizontally extending groove 42 of a first block 10 in a wall separates and extends between the surface portions 24, 26 of the first block and the surface portion 28 of a second block stacked directly on top of the first block.

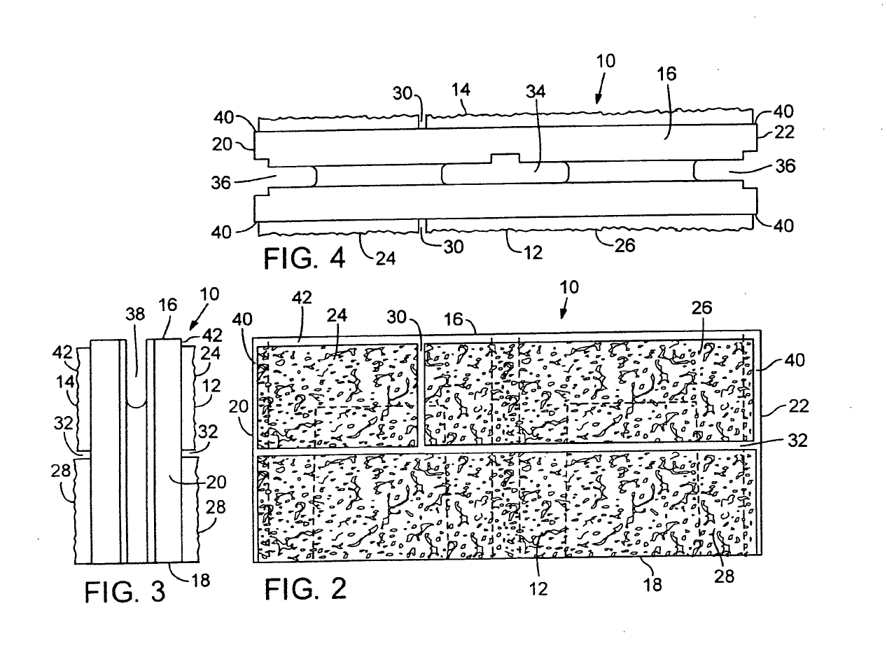

While the block 10 in illustrated embodiment is formed with three surface portions on each face of the block, the block can have any number of surface portions on one or both faces of the block. For example, a block face 12, 14 can be formed with only one recessed portion extending horizontally across the block face to separate the block face into an upper surface portion and a lower portion, or with only one recessed portion extending vertically across the block face to separate the block face into left and right surface portions. As another example, a block face can be formed with multiple horizontal and/or vertical recessed portions to separate the block face into any number of surface portions. In addition, a surface portion can be the same size as or a different size than another surface portion in the same block face. For example, the vertical recessed portion 30 (FIG. 2) can be equally spaced between the side surfaces 20, 22 of the block to form first and second surface portions 24, 26 that are the same size as each other.

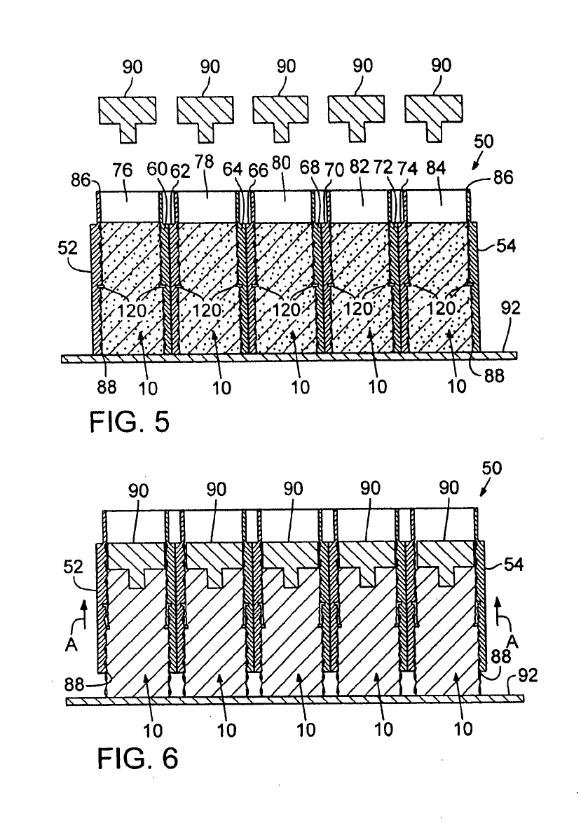

As shown, the surface portions 24, 26, 28 desirably have a roughened surface texture resembling a split block. In particular embodiments, the roughened surface texture is formed on the surface portions as the uncured block is removed from a mold, as described in detail below. The block 10 can be formed in a mold that is adapted to form one block at a time or a mold that is adapted to form multiple blocks in single block-forming cycle. FIGS. 5-8 show a mold 50, according to one embodiment, that can be used to form up to five blocks 10 in a one cycle.

As best shown in FIG. 8, the mold 50 can include end walls 52, 54, side walls 56, 58 extending between respective ends of the end walls 52, 54, and a plurality of internal walls, or dividing plates, 60, 62, 64, 66, 68, 70, 72, 74 extending between the side walls 56, 58 to form a plurality of separate mold cavities 76, 78, 80, 82, 84 (FIG. 5). Each mold cavity in the illustrated configuration has an open upper end 86 through which block-forming material can be introduced into the cavity and an open lower end 88 through which a formed block 10 in an uncured state can be removed, or stripped, from the cavity. The mold 50 can be supported on any suitable support surface, such as a pallet 92 illustrated schematically in FIGS. 5-7.

The mold 50 may be adapted for use with any conventional block-forming machine, such as those available from Columbia Machine (Vancouver, Wash.), Masa-USA, LLC (Green Bay, Wis.), Knauer Engineering (Germany), Besser, Inc. (Alpena, Mich.), Tiger Machine (Japan), or Hess Machinery (Ontario, Canada), to name a few.

A substantially horizontally disposed shoe, or plate, 90 (commonly referred to as a “mold head”) may be provided above each mold cavity to facilitate compression of the block-forming material during the block forming process and removal of the formed, uncured blocks 10 from the mold cavities. The shoes 90, each of which is shaped so as to be able to fit slidably within a respective mold cavity, is operable for movement between a raised position above the mold 50 (FIG. 5) and a lowered position within the mold cavities for compressing the block-forming material and for removing the formed, uncured blocks from the mold cavities (FIG. 6). The shoes 90 may be coupled to any suitable mechanism for moving them between the raised and lowered positions and for pressing them against the top surfaces of the blocks 10. For example, the shoes 90 may be coupled to a hydraulic ram, as generally known in the art.

Forms or core bars (not shown) for forming the cores 34, 36 and the channel 38 in each block can be inserted into the mold cavities. The forms can be supported by bars (not shown) that extend transversely across the open top of the mold 50 and are supported by the side walls 56, 58 of the mold, as known in the art.

The shape of the mold cavities define the plan shape and size of the blocks 10 (i.e., the shape and size of the block when viewed from above or below), with the vertical walls of the mold forming the vertical surfaces (the first and second faces 12, 14 and side surfaces 20, 22) of the blocks 10. The bottom and top surfaces of the blocks 10 can be formed by the upper surface of the pallet 92 and the lower surfaces of the shoes 90, respectively.

The end walls 52, 54, and the internal walls 60-74, each have interior surfaces configured to texture adjacent surfaces of the uncured blocks 10 as they are removed from their respective mold cavities, as explained in greater detail below. Each mold cavity in the configuration shown has a generally rectangular plan shape to provide a block having the same shape. However, the shape of each mold cavity can be varied to provide blocks having other geometrical plan shapes. For example, one or more of the walls defining a mold cavity can be configured to intersect an adjacent wall at an angle that is greater than or less than 90 degrees. In addition, one or more of the walls of a mold cavity may be curved or rounded. Alternatively, a wall may comprise plural segments interconnected to each other at angles. Moreover, a mold cavity may have greater than or less than four vertical walls.

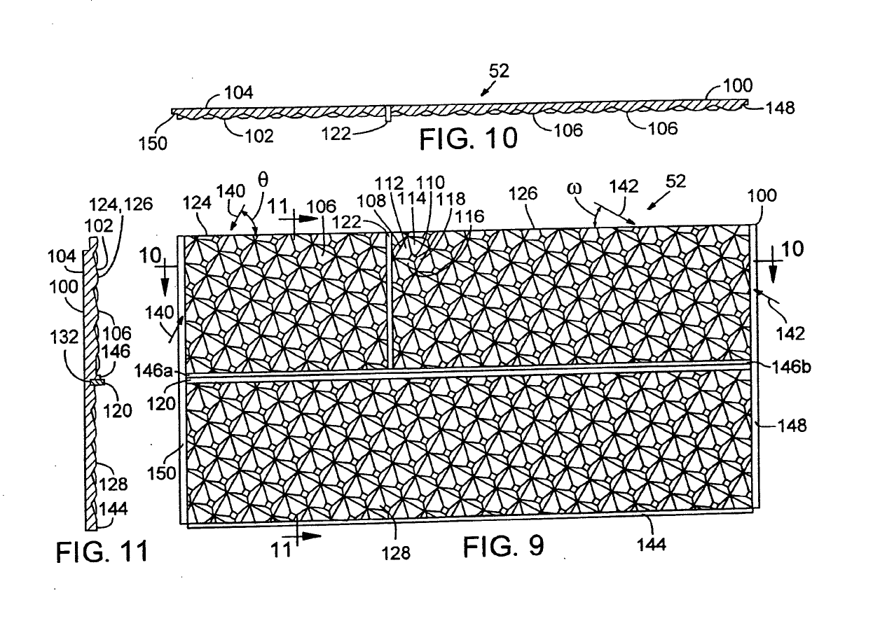

FIGS. 9-11 illustrate in greater detail the end wall 52 of the mold 50 shown in FIGS. 5-8. In the illustrated embodiment, the end wall 52 is identical in construction to the end wall 54 and the internal walls 60-74. Thus, the following description, which proceeds in reference to the end wall 52, is also applicable to the end wall 54 and the internal walls 60-74.

The wall 52 in the illustrated configuration comprises a body 100 having a first major surface 102, which serves as an interior surface of the mold cavity 76, and second major surface 104. As used herein, the “major surfaces” of the mold wall refer to largest surfaces of the wall (the surfaces of the wall with the largest surface areas). A plurality of abutting block-texturing members, or projections, 106 extend outwardly from the first surface 102. As shown in FIGS. 5 and 6, the projections 106 on the walls 52, 60 project into the mold cavity 76 and contact adjacent surfaces of the block 10. As the mold 50 is moved vertically with respect to the block 10 for removing the block from the mold cavity 76, as indicated by arrow A in FIG. 6, the projections 106 produce a “scraping,” or “tearing,” action on the respective adjacent surfaces of the block 10, thereby creating an irregularly roughened surface for those sides of the block 10. As shown in FIG. 9, the wall 52 can have flat side portions 148, 150 extending vertically between the upper and lower edges of the wall 52, which side portions 148, 150 are not formed with any projections.

As shown in FIGS. 9-11, the projections 106 desirably taper as they extend outwardly from the first surface 102. In the illustrated embodiment, for example, each projection 106 is generally “frusto-pyramidal” in shape, that is, each projection 106 has a square-shaped base 108 at the first surface 102, a flattened, square-shaped end surface or crest 110 spaced from the base 108, and four flat side surfaces 112, 114, 116 and 118 that converge as they extend from the base 28 to the end surface 30. However, other tapered or non-tapered shapes may be used for the projections 106. For example, the projections 106 may be pyramidal, conical, frusto-conical, rectangular, square, cylindrical, or any of other various shapes.

Desirably, the projections 106 are distributed uniformly throughout the surface area of the first major surface 102 except at side portions 148, 150. As best shown in FIG. 9, the projections 106 in the illustrated embodiment are arranged side-by-side in diagonal rows extending across the first surface 102 without spacing between projections or between adjacent rows of projections, except for an elongated horizontal bar 120 and an elongated vertical bar 122 that extend across the first major surface 102. In other embodiments, the rows of projections 106 may extend horizontally across the first surface so as to form a “checkerboard” pattern of projections. In addition, in other embodiments, the projections 106 may be spaced apart in the direction of the rows of projections. In still other embodiments, the rows of projections may be spaced from each other.

As shown in FIG. 9 and except for those projections bordering side portions 148, 150, the base 108 of each projection 106 adjoins the base 108 of an adjacent projection to minimize spacing between the crests 110 of adjacent projections. The side surfaces 112, 114 of each projection 106 face in a generally upward direction and the side surfaces 116, 118 of each projection 106 face in a generally downward direction. Thus, it can be seen that the side surfaces 116, 118, along with the end surface or crest 110, of each projection 106 produce the scraping action against the adjacent surface of the block 10 as the wall 52 is moved vertically with respect to the block 10 in the direction of arrow A.

In the illustrated embodiment, the side surfaces 112, 114 of the projections 106 have slopes that are less than the slopes of the side surfaces 116, 118. This minimizes the likelihood of block-forming material being retained in the spaces between adjacent projections as the block 10 is being removed from the mold cavity 76. In an alternative embodiment, the side surfaces 112, 114, 116, 118 of each projection can be oriented at the same angle with respect to the interior surface of the wall.

The elongated bars 120, 122 project into the mold cavity to form the recessed surface portions 32, 30 (FIG. 1), respectively, in the adjacent face 12, 14 of the uncured block 10 in the mold cavity. As shown in FIG. 9, the elongated bar 120 extends horizontally across the first major surface 102 between the vertical sides of the wall 52, thereby separating the projections 106 into upper and lower sections. The elongated bar 122 extends vertically from the upper edge of the wall 52 to the horizontal bar, thereby further dividing the upper section of projections. The elongated bars 120, 122 in the illustrated embodiment therefore define a first set of projections 124, a second set of projections 126 separated from the first set by the vertical bar 122, and a third set of projections 128 separated from the first and second sets by the horizontal bar 120. The first, second, and third sets of projections 124, 126, 128 texture the surfaces of the first, second, and third surface portions 24, 26, 28 (FIG. 1), respectively, of the adjacent face 12, 14 of the uncured block as it is removed from the mold 50, as described in greater detail below.

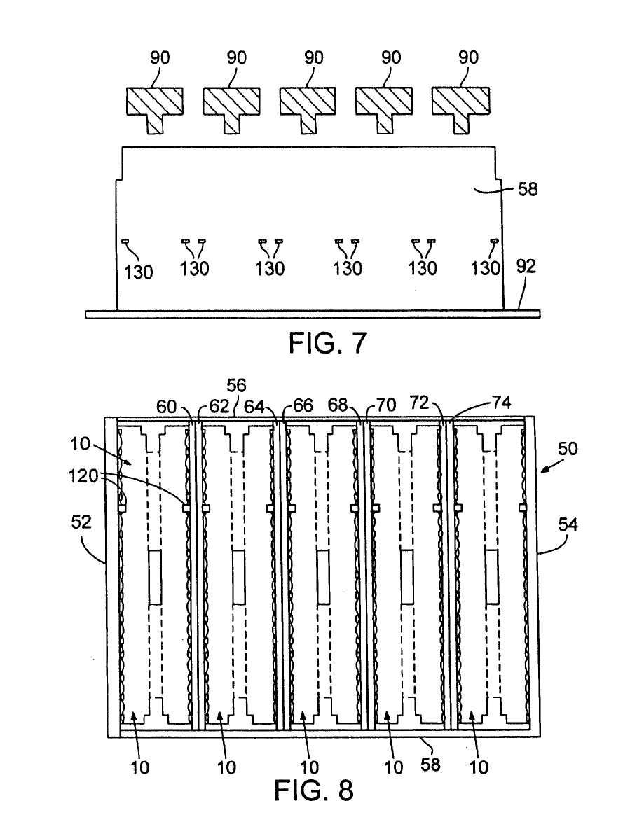

In particular embodiments, the horizontal bar 120 is adapted to be removed from the mold cavity 76 before the uncured block 10 is removed therefrom. In this regard, the first major surface 102 of the wall 52 can be formed with an elongated notch 132 (FIG. 11) that slidably receives the bar 120 and allows the bar to be slid longitudinally within the notch 132 in a horizontal direction relative to the wall 52. As shown in FIG. 7, the side wall 58 of the mold 50 can be formed with a plurality of openings 130 (two openings 130 per mold cavity in the illustrated example) for removing the bars 120 from the respective mold cavities 76, 78, 80, 82, 84. Each bar 120 can be connected to a conventional core puller assembly that is operable to “pull” or remove the bar from the mold in a horizontal direction via the openings 130.

As best shown in FIG. 11, the projections 106 of the first and second sets 124, 126 of projections (the projections on the upper half of the mold wall in the illustrated example) are offset inwardly relative to the projections 106 of the third set 128 of projections (the projections on the lower half of the mold wall in the illustrated example). In this manner, the projections 106 of the first and second sets 124, 126 extend into the mold cavity 76 a greater distance than the projections 106 of the third set 128 of projections. This allows the block 10 to be stripped from the mold without the projections 106 of the third set 128 of projections contacting the recessed portion 32 (FIG. 2) formed in the face of the uncured block, thus preserving the recessed portion 32 as the block is removed from the mold, as further described below.

As shown in FIG. 11, the bottom edge of the mold wall 52 can include a horizontally extending lip, or screed, 144 that extends lengthwise of the wall between the side edge portions 148, 150. The screed 144 desirably projects inwardly (in a direction into the mold cavity) approximately the same distance as the projections 106 in the third set of projections 128. The screed 144 functions to flatten or smooth out any high points on the surface portion 28 (FIG. 1) of the block as the mold moves vertically relative to the block when the block is removed from the mold.

Similarly, another lip, or screed, 146 can be provided below the projections of the first and second sets of projections 124, 126. As shown in FIG. 9, the screed 146 has a first screed portion 146a that extends lengthwise of the wall between side edge portion 150 and the vertical bar 122 and a second screed portion 146b that extends lengthwise of the wall between side edge portion 148 and the vertical bar 122. The screed portions 146a, 146b desirably project inwardly approximately the same distance as the projections 106 in the first and second sets of projections 124, 126. The screed portions 146a, 146b flatten or smooth out any high points on the surface portions 24, 26 of the block as it is removed from the mold.

In particular embodiments, the diagonal rows of projections 106 extend at angles less than or greater than 45 degrees with respect to the upper and lower edges of the mold wall. As shown in FIG. 9, the rows extending upwardly left to right, such as row 140 form an angle θ with respect to the upper edge of the wall, and the rows extending upwardly right to left, such as row 142, form an angle ω with respect the upper edge of the wall wherein the angle co is different than the angle θ. Consequently, the crests 110 of the projections 106 are not vertically aligned from the upper edge to the lower edge of the wall. Advantageously, this provides for a more consistent surface texture on the face of a block.

In an exemplary embodiment, the rows extending upwardly left to right, such as row 140, are oriented at an angle θ of about 60 degrees with respect to the wall upper edge, and the rows extending upwardly right to left, such as row 142, form an angle ω of about 30 degrees with respect the wall upper edge. In an alternative embodiment, the angles θ and ω are 45 degrees, in which case crests 110 of the projections are vertically aligned from the upper edge to the lower edge of the wall, as disclosed in U.S. Pat. No. 7,100,886, which is incorporated herein by reference.

Although each mold cavity of the illustrated mold 50 is shown as having two walls for texturing opposed surfaces of each block 10, in other embodiments, only one such wall may be used for each mold cavity, or alternatively, two adjacent such walls may be used, or more than two walls for texturing the surfaces of a block may be used. For example, selected portions of the side walls 56, 58 can have projections for texturing one or both side surfaces 20, 22 of one or more blocks 10.

In addition, a wall of the mold can be provided with plural bars 120 and/or plural bars 122 to form any number of roughened surface portions separated by recessed portions in a face 12, 14 of the block 10. Moreover, a wall can be provided with only horizontal bar(s) 120 or with only vertical bar(s) 122. If a wall does not have any horizontal bars 120, all of the projections 106 on the wall can extend into the mold cavity the same distance (i.e., the sets of projections are not offset from each other) because stripping the block from the mold in this instance would not obliterate the recessed portions formed by the vertical bar(s) 122.

In the embodiment of FIGS. 9-11, the wall 52, the projections 106, and the vertical bar 122 are of a unitary, monolithic construction. The wall 52 may be formed by machining the projections 106 and the bar 122 into one surface of a piece material used to form the mold wall.

In one specific implementation, the projections 106 are machined in a piece of material (e.g., steel) to a depth of about ¼ inch. The width of each projection is about 0.87 inch at their respective bases 108 and about 0.19 inch at their respective end surfaces 110. The end surfaces 110 of the projections 106 of the first and second sets 124, 126 are offset from the end surfaces of the projections 106 of the third set 128 by a distance of about 1/16 inch to about ⅛ inch. Of course, these specific dimensions (as well as other dimensions provided in the present specification) are given to illustrate the invention and not to limit it. The dimensions provided herein can be modified as needed in different applications or situations.

In other embodiments, the projections 106 and/or the vertical bar 122 may be separately formed and then coupled or otherwise mounted to the mold wall, such as by welding or with conventional releasable fasteners (e.g., bolts). If releasable fasteners are used, the bar and/or the projections can be removed and replaced with new components when the existing components become worn or otherwise deviate from desired tolerances.

In the illustrated embodiment, as shown in FIG. 5, the internal walls 60, 62 are placed back-to-back and the projections thereon extend into respective mold cavities 76, 78. Similarly, internal wall 64 is placed back-to-back with internal wall 66; internal wall 68 is placed back-to-back with internal wall 70; and internal wall 72 is placed back-to-back with internal wall 74. In an alternative embodiment, a single internal wall formed with projections 106 on both sides (if both sides of the uncured blocks are to be textured by projections) can be used to separate or divide the mold cavities. If only one face 12, 14 of each block 10 in the mold is to be textured by projections, then only one of the walls forming each mold cavity need be provided with projections 106. For example, to form blocks 10 wherein only one face 12, 14 is provided with a roughened surface portion, internal walls 62, 66, 70, 74 can be removed and internal walls 60, 72 can be provided with flat surfaces without any projections on either side.

In still other embodiments, any of the walls 52, 54, 60, 62, 64, 66, 68, 70, 72, 74 can be used as “inserts” for an existing mold wall. For example, an insert having the same configuration as end wall 52 can be placed in the mold cavity 76 against the inner surface of an existing end wall of the mold. When used in this manner, the inserts can be secured to the interior surfaces of existing walls of a mold using suitable techniques or mechanisms, such as using bolts or by welding the inserts in place.

Explaining the operation of the mold, according to one specific approach, and referring initially to FIG. 5, the mold 50 and the pallet 92 can be moved into place under the shoes 90, such as by way of a conveyor (not shown), so that each shoe is aligned over a respective mold cavity. The mold 50 is then loaded with a flowable, composite cementitious fill material through the open top of the mold. Composite fill material generally comprises, for example, aggregate material (e.g., gravel or stone chippings), sand, cement, and water, as generally known in the art. The fill material also may comprise other ingredients, such as pigments, plasticizers, and other fill materials, depending upon the particular application. Other flowable, block-forming materials can be used if forming blocks from non-cementitious materials, and in particular, any granular, flowable material that can form a green-state (uncured) block that is free-standing or self-supporting when stripped from a mold (the green-state block retains its shaped when stripped from the mold).

The mold 50, or the pallet 92, or a combination of both may be vibrated for suitable period of time to assist in the loading of the mold 50 with fill material. The shoes 92 are then lowered into the mold cavities 76, 78, 80, 82, 84, against the top of the mass of fill material in each cavity. The shoes 92 desirably are sized so as to provide a slight clearance with the projections 106 when lowered into the mold cavities. Additional vibration, together with the pressure exerted by the shoes acts to densify the fill material and form the final shape of the blocks 10.

After the blocks 10 are formed, the horizontal bars 120 are removed from the mold via openings 130 (FIG. 7), such as by activating core puller assemblies connected to the bars 120. Subsequently, the formed, uncured blocks 10 are removed from the mold such as by raising the mold 50 (as indicated by arrow A in FIG. 6), while maintaining the vertical position of the shoes 90 and the pallet 92 so that the blocks 10 are pushed through the bottom openings 88 of the mold cavities. As the mold moves upwardly relative to the uncured blocks, the projections 106 pass upwardly through the uncured concrete as the concrete flows around the projections. Alternatively, the blocks 10 can be pushed through the mold cavities by moving the shoes 90 through the mold cavities, while simultaneously lowering the pallet and maintaining the vertical position of the mold 50. In either case, the action of stripping the blocks 10 from the mold 50 creates a roughened texture on the adjacent surfaces of the blocks that contact the projections 106.

More specifically, the projections 106 of the first, second, and third sets of projections 124, 126, and 128 of a mold wall (FIG. 9) contact surface portions 24, 26, and 28, respectively, of an adjacent block face 12, 14 and create roughened textures on those surface portions. Because the projections 106 of the first and second sets of projections 124, 126 (the upper projections) are offset inwardly relative to the projections of the third set of projections 128 (the lower projections), the latter projections do not contact the recessed portion 32 as the block is removed from the mold, and therefore the recessed portion 32 remains in tact after the block is clear of the mold. Each face 12, 14 of the block is therefore formed with roughened surface portions 24, 26, 28 separated by recessed portions 30, 32, thereby resembling the faces of two blocks stacked on top of another block (FIGS. 1 and 2). As best shown in FIG. 3, due to the offset of the projections, the first and second surface portions 24, 26 are recessed slightly relative to the third surface portion 28 such that the upper half of the block 10 has a smaller width (measured between faces 12, 14) than the lower half of the block. When stacked in courses with like blocks 10, the offset between the surface positions provides a staggered appearance akin to a natural stone wall.

Advantageously, unlike some prior art devices, the mold does not require concrete fill material to be retained on the inner surfaces of the mold walls for the purpose of creating roughened surfaces on the block. As such, the mold does not require frequent stoppages in production to clear material from the walls of the mold. Other techniques also can be used to minimize the retention of concrete on the inner surfaces of the mold, for example, a concrete release agent can be applied to the inner surfaces of the mold, wire brushes can be mounted to shoes 90 and positioned to sweep or brush the inner surfaces of the mold walls as the blocks are stripped from the mold, and/or compressed gas nozzles can be positioned to directed compressed gas (e.g., compressed air) against the inner surfaces of the mold after the blocks are removed from the mold to blow away excess concrete from the inner surfaces of the mold.

Because the amount of fill material, if any, retained on projections 106 is minimal, the blocks 10 produced by the mold can maintain their dimensional tolerances through multiple cycles. Thus, in the illustrated example, the roughened surfaces 24, 26, 28 of the block 10 are substantially perpendicular to the top and bottom of the block. Also, the portion of the block from the bottom 18 to the recessed portion 32 (the lower half of the block) exhibits a substantially constant first cross-sectional profile and the portion of the block from the recessed portion 32 to the top 16 of the block (the upper half of the block) exhibits a substantially constant second cross-sectional profile that is slightly smaller in width than the first cross-sectional profile (see FIG. 3).

The mold filling time, the vibration times and the amount of pressure exerted by the shoes 90 are determined by the particular block-forming machine being used, and the particular application. After the blocks are removed from the mold 50, they may be transported to a suitable curing station, where they can be cured using any suitable curing technique, such as, air curing, autoclaving, steam curing, or mist curing.

In alternative embodiments, the bar 120 can extend diagonally across the surface of a wall (in a direction that is non-parallel to the upper and lower edges of the wall) to form a non-horizontal or diagonally extending recessed portion on the face 12, 14 of the block 10. As can be appreciated, this would form roughened surface portions 24, 26, 28 having non-parallel sides. In this alternative embodiment, the bar 120 can be removed from the mold through an opening 130 in a side wall in a direction that is non-perpendicular and non-parallel to the direction of the mold upon removal of the block (the direction of arrow A in FIG. 6).

In another implementation, a mold wall (e.g., wall 52) can be without any bars 120, 122 and instead can be formed with flat surface portions separating the sets of projections 124, 126, 128 so as to form generally smooth, non-roughened surface portions extending between and separating the roughened surface portions 24, 26, 28 in the face 12, 14 of the block 10. In another implementation, the first and second sets of projections 124, 126 can be offset from the third set of projections 128 as shown in FIG. 11 without a bar 120 and without any spacing between the lowermost projections of the first and second sets and the uppermost projections of the third set. The latter implementation forms a block having roughened surface portions 24, 26 that are offset from roughened surface portion 28 without a notch or a non-roughened surface separating surface portions 24, 26 from surface portion 28.

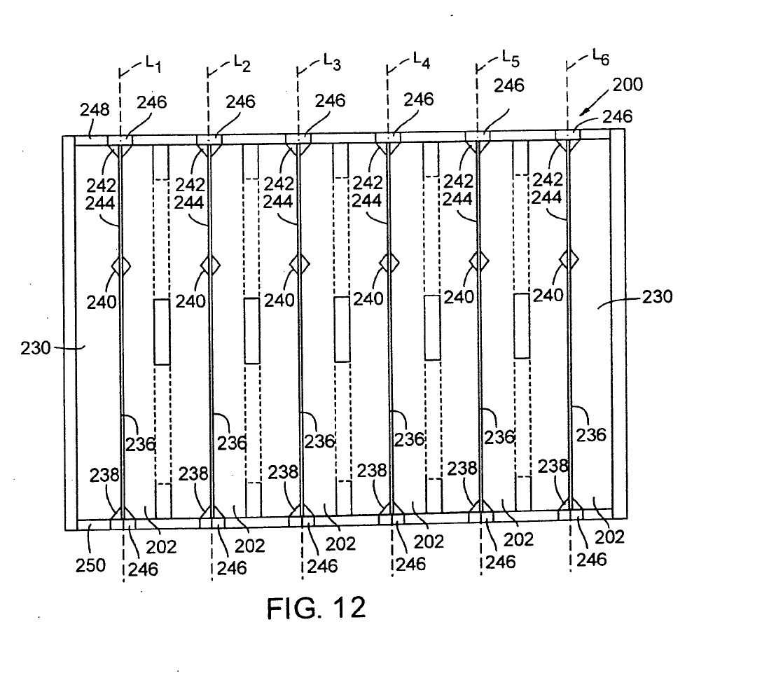

FIG. 12 shows a top plan view of another embodiment of a mold, indicated at 200, that can be used to produce one or more blocks 202. While the illustrated mold is specifically adapted to form five such blocks 202, the mold can be sized to form a greater or fewer number of blocks 202.

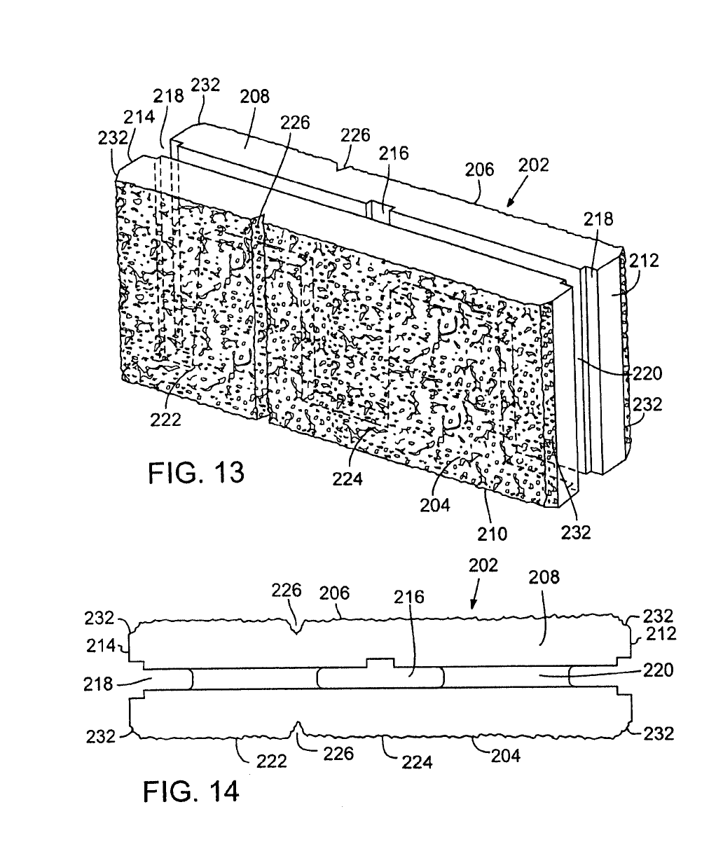

FIGS. 13 and 14 show a perspective view of an individual block 202. The block 202 in the illustrated configuration includes first and second faces 204 and 206, respectively, a top surface 208, a bottom surface 210, and side surfaces 212, 214 extending between the first and second faces. The block 202, like the block 10, can be used to construct a free-standing wall or fence having two exposed wall surfaces. The block 202 can be formed with a centrally located, vertical core 216, vertical cores 218 at opposite sides of the block, and a horizontally extending channel, or trough, 220 opening at the sides 212, 214 and at the top surface 208 of the block.

In this embodiment, each of the first and second faces 204, 206 can be formed with first and second roughened surface portions 222 and 224, a vertically extending, V-shaped recessed portion, or elongated notch, 226 separating the first and second surface portions 222, 224. The recessed portion 226 extends from the top surface 208 to the bottom surface 210 of the block. Each face 204, 206 also can be formed with two angled recessed portions 232 extending between the top surface 208 and the bottom surface 210 on opposite sides of the respective face at the side surfaces 212, 214 of the block. The recessed portions 226, 232 can have roughened surface textures similar to surface portions 222, 224.

In the embodiment shown in FIG. 12, divider plates do not separate individual blocks in the mold 200. Instead, the mold 200 forms a larger unitary block, or block module, comprised of interconnected blocks 202 connected to each other where the faces 204, 206 are to be formed. Sacrificial portions 230 can be formed at the opposite ends of the block module. After the block module is removed from the mold and cured, the sacrificial portions 230 can be split from the block module along imaginary lines L₁ and L₆, and the block module can be further split at predetermined locations along imaginary lines L₂, L₃, L₄, and L₅ to separate the block module into individual blocks 202, each having split faces 204, 206. Thus, in this specific implementation, the surface portions 222, 224 of each face are provided with a roughened texture by splitting the block, which can be achieved using conventional techniques or mechanisms. Splitting grooves or notches (not shown) can be formed on the upper surface of the block module along lines L₁, L₂, L₃, L₄, L₅, L₆ to facilitate splitting of the block module into individual blocks 202.

As noted above, the recessed portions 226, 232 of the block also can be provided with a roughened surface texture (as shown in FIG. 13). This can be accomplished by forming the recessed portions 226, 232 using core bars, or forms, that are configured to create a roughened surface texture on the surfaces of the block contacting the core bars as the uncured block module is removed from the mold. For example, as shown in FIG. 12, the mold 200 can be provided with a plurality of core bar assemblies 236 extending transversely of the mold and positioned along imaginary lines L₁, L₂, L₃, L₄, L₅, L₆ where the block module is to be split.

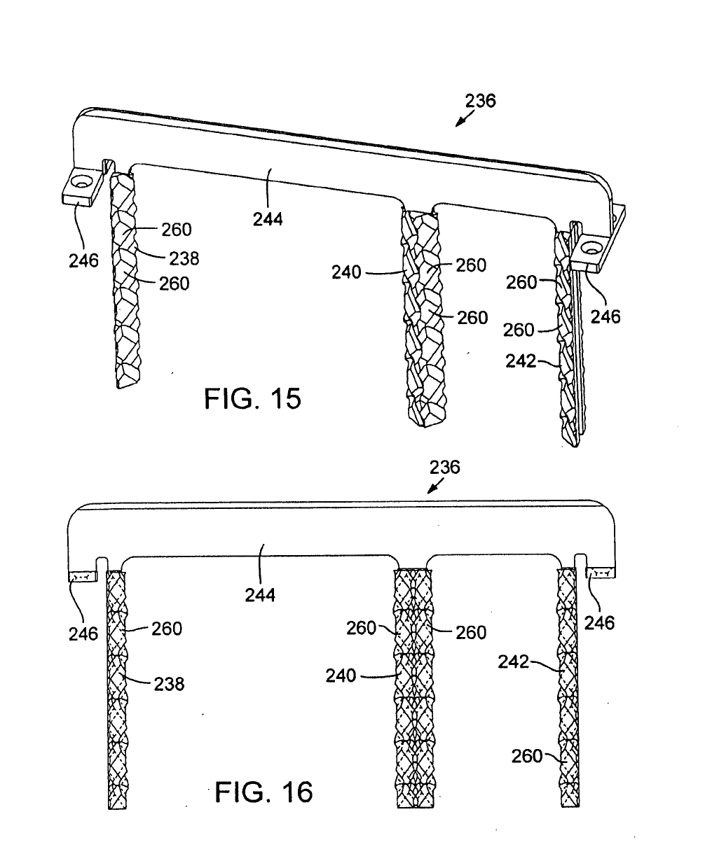

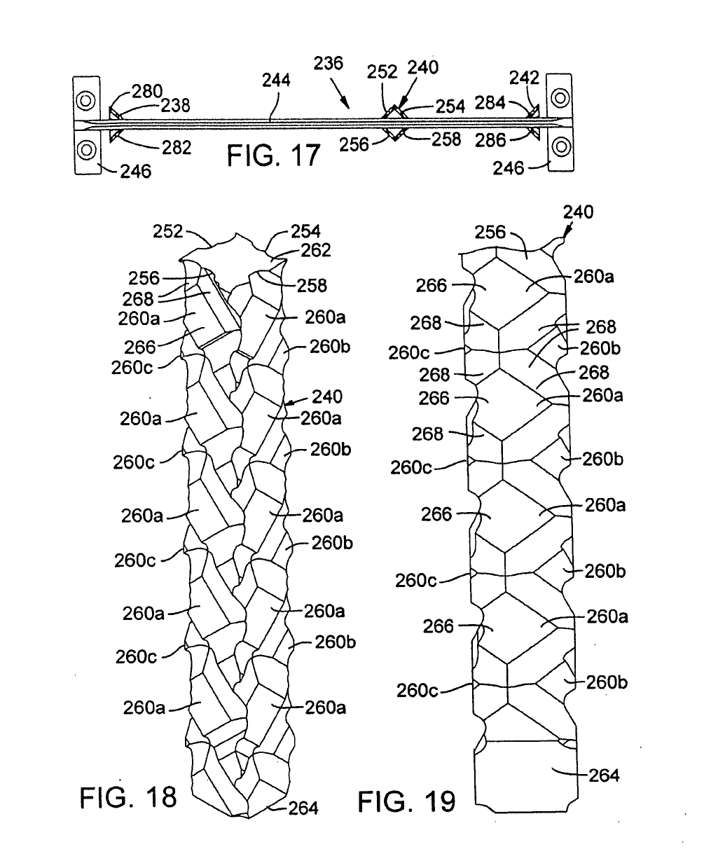

As shown in FIGS. 15-17, each core bar assembly 236 in the illustrated embodiment can include first, second, and third core bars 238, 240, and 242, respectively, that are supported at their upper ends by a hanger bar 244. Pads, or feet, 246 can be connected to the opposite end portions of the hanger bar 244. As shown in FIG. 12, the feet 246 of each core bar assembly 236 are supported on the upper surfaces of the side walls 248, 250 of the mold 200 such that the hanger bar 244 is supported above the upper opening of the mold and the core bars 238, 240, 242 extend downwardly into the mold cavity. The core bars 238 form the recessed portions 226 in the blocks 202 while the core bars 240, 242 form the recessed portions 232 in the blocks 202, as described in greater detail below.

As best shown in FIGS. 18-22, the core bar 240 in the illustrated configuration comprises an elongated body having sides 252, 254, 256, 258 oriented at 90 degrees relative to each other. Each side 252, 254, 256, 258 is formed with a plurality of tapered projections 260 that create a roughened surface texture on the surfaces of the block contacting the core bar 240 as the uncured block module is removed from the mold. The shape and arrangement of the projections 260 in the illustrated embodiment is similar to the projections 106 formed on the mold wall 52 (FIGS. 9-11). In other words, extending the pattern of projections 260 on each side of the core bar in an imaginary plane beyond the vertical edges of the core bar would form a pattern of projections 260 comprising multiple rows of projections 260 extending diagonally between the top and bottom surfaces 262, 264, respectively, of the core bar much like the pattern of projections 106 on the mold wall 52.

The projections 260 can be machined or otherwise formed in the sides of the core bar 240 such that each projection forms a portion of a frusto-pyramid. For example, as best shown in FIG. 19, the size of the frusto-pyramids relative to the width of the core bar 240 in the illustrated configuration is such that each side of the core bar 240 can be formed with projections 260a comprised of relatively large portions of frusto-pyramids arrayed along the length of the side, projections 260b comprised of smaller portions of frusto-pyramids interposed between projections 260a, and projections 260c comprised of still smaller portions of frusto-pyramids interposed between the projections 260a opposite the projections 260b. Each projection 260a, 260b, 260c can have a flattened upper surface, or crest, 266, and one or more angled side surfaces 268.

In alternative embodiments, however, each side of the core bar can be formed with fully formed frusto-pyramids. In addition, other tapered or non-tapered shapes may be used for the projections 260. For example, the projections 260 may be pyramidal, conical, frusto-conical, rectangular, square, cylindrical, or portions thereof, or any of various other shapes.

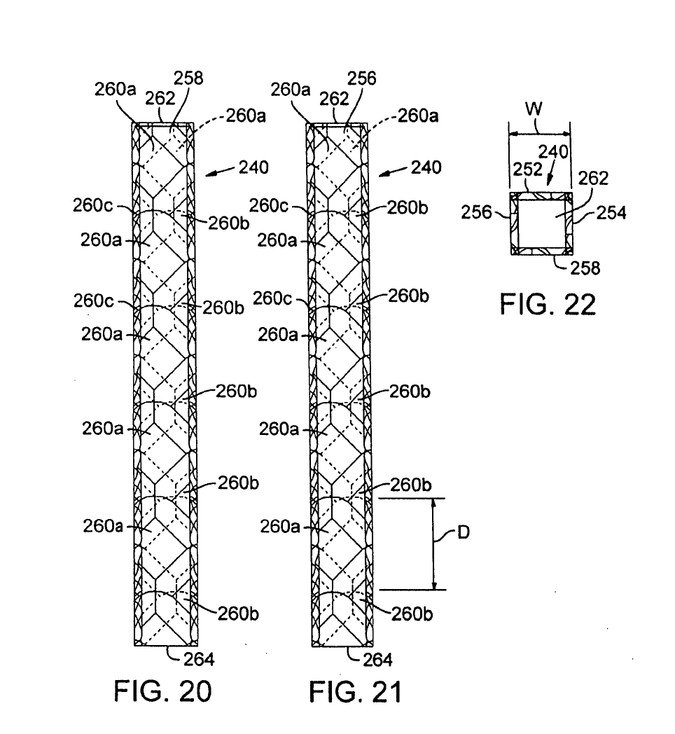

As shown in FIG. 18, the projections formed on each side of the core bar 240 desirably are offset from the projections formed on the adjacent sides of the core bar in a direction extending lengthwise of the core bar. For example, the projections 260a, 260b, and 260c formed on side 256 are offset longitudinally from the projections formed on side 258 and from the projections formed on side 252. In addition, as shown in FIGS. 20 and 21, the projections formed on one side of the core bar desirably are offset laterally or widthwise of the core bar from the projections formed on the opposite side of the core bar. For example, the projections 260a, 260b, 260c formed on side 258 (shown in solid lines in FIG. 20) are offset laterally from the projections 260a, 260b, 260c on the opposite side 252 (shown in dashed lines in FIG. 20). Similarly, as shown in FIG. 21, the projections 260a, 260b, 260c formed on side 256 (shown in solid lines in FIG. 21) can be offset laterally from the projections 260a, 260b, 260c on the opposite side 254 (shown in dashed lines in FIG. 21).

In a specific implementation, the projections are machined in a steel bar having a square cross-section profile and a width W (FIG. 22) of about 1.061 inches. The projections are machined to a depth of about 0.125 inch. The distance D (FIG. 21) from a lower corner of a projection at its base to an upper corner of the projection at its base is about 1 inch to about 1¾ inches, and in particular embodiments, about 1¼ inches to about 1⅝ inches, with about 1½ inches being a specific example.

As shown in FIGS. 15-17, the core bar 238 in the illustrated embodiment has two sides 280, 282 that are formed with projections 260 comprised of portions of frusto-pyramids for texturing surfaces of an uncured block contacting the core bar. Similarly, the core bar 242 can be formed with projections 260 on sides 284, 286.

Referring again to FIG. 12, a method for forming blocks 202 using the mold 200 includes introducing block-forming material into the opening of the mold. The core bars 238, 240, 242 of each core bar assembly extend downwardly into the mold to form vertically extending cores or voids in the block module. The mold 200 can be vibrated to facilitate loading of the mold with block-forming material. Subsequently, the uncured block module can be removed from the mold, for example, by lowering shoes onto the top of the block module between the core bar assemblies and raising the mold to push the block module through the bottom opening of the mold.

The action of removing the block module from the mold causes the projections 260 to be drawn across the surfaces of the cores, thereby creating roughened surface textures on those surfaces. After a suitable curing period, the block module can be split along lines L₁, L₂, L₃, L₄, L₅, L₆ to separate the block module into individual blocks 202. As can be seen in FIG. 12, the block module is split along vertical planes extending through the cores formed by core bars 238, 240, 242 in a direction extending lengthwise of the cores. As such, once the block module is split, the cores formed by core bars 240 form the recessed portions 226 (FIG. 13) in the faces 204, 206 of the blocks and the cores formed by core bars 238, 242 form the recessed portions 232 (FIG. 13) at the sides of the block faces 204, 206.

Alternatively, the core bars 238, 240, 242 can be used to form roughened surface portions on the uncured block by removing the core bars from the mold such as with conventional core pullers before the uncured block is removed from the mold. It can be appreciated that movement of the core bars relative to the uncured block whether by removing the core bars from the mold or stripping the block from the mold is effective to form roughened surface textures on the surfaces contacting the core bars.

If desired, core bars can be used to form notches or grooves extending horizontally or diagonally across the faces 204, 206 of the block 202. For example, core bars 240 can be positioned horizontally in the mold 200 along lines L₁, L₂, L₃, L₄, L₅, L₆ (FIG. 12). After block-forming material is introduced in the mold 202, the horizontal core bars 240 can be removed from the mold through corresponding openings in a vertical side wall of the mold, such as by using core pullers. The horizontal core bars form horizontally extending notches having roughened surfaces on the faces of the blocks forming the block module. The block module can then be removed from the mold, allowed to cure, and split along lines L₁, L₂, L₃, L₄, L₅, L₆ as described above to form multiple blocks. The resulting blocks have vertical extending notches 226 (as shown in FIGS. 13 and 14) as well as horizontally extending notches formed in the block faces 204, 206. In another embodiment, horizontal core bars can be used without vertical core bars to form blocks with only horizontally extending notches.

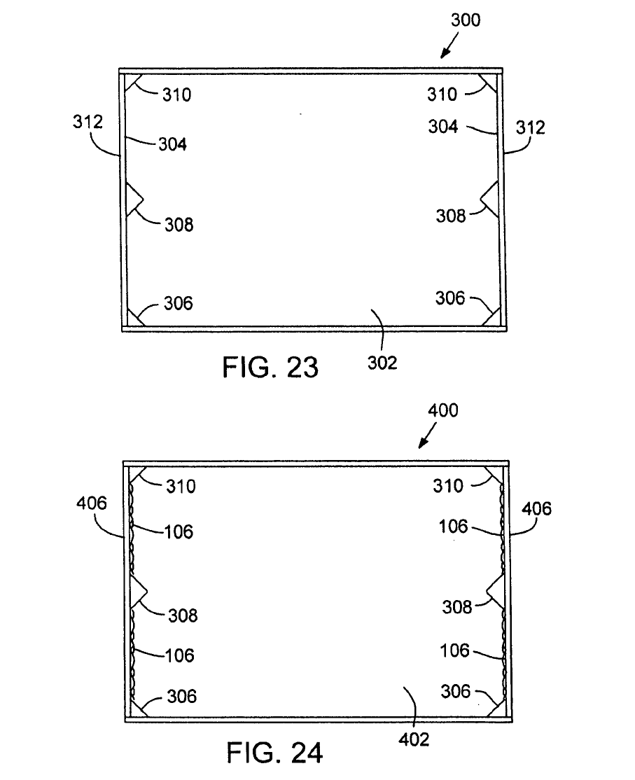

In alternative embodiments, one or more core bars having projections 260 can be used to form notches or grooves in the surface of a block face that is not formed by splitting. For example, FIG. 23 shows a schematic top plan view of a mold 300 for forming a block 302. A core bar assembly 304 can be placed across the top of the mold 300 at one or both ends of the mold. Each core bar assembly has one or more core bars 306, 308, 310 extending downwardly into the mold. Each core bar 306, 308, 310 can be formed with projections 260 (not shown in FIG. 23) on the surfaces of the core bars contacting the uncured block in the mold. Removing the uncured block from the mold forms vertically extending recessed portions having roughened surface textures in the faces of the uncured block 302. The end walls 312 of the mold can have flat inner surfaces contacting the faces of the uncured block between the core bars 306, 308, 310 to form flat, non-roughened surfaces between the recessed portions formed by the core bars.

In further embodiments, one or more core bars having projections 260 can be used in combination with a mold in which one or more inner surfaces are formed with block-texturing projections (e.g., projections 106 shown in FIGS. 9-11). For example, FIG. 24 shows a schematic top plan view of a mold 400 for forming a block 402. The mold 400 is adapted to receive core bars 306, 308, 310 at one or both ends of the mold (the cross bars used to support the core bars are removed for clarity). The mold has end walls 406 formed with a plurality of rows of projections 106 extending across the inner surfaces of the end walls except in the areas covered by the core bars 306, 308, 310. In use, the uncured block can be stripped from the mold 400, which causes the core bars 306, 308, 310 to form corresponding vertically extending recessed portions having roughened surface textures in the faces of the uncured block. Removal of the uncured block from the mold also causes the projections 106 to create roughened surface textures on the surface portions of the block faces between the recessed portions.

In still further embodiments, one or more core bar having projections 260 can be used to form horizontally extending notches or recessed portions in the surface of a block. In one specific implementation, for example, core bars having a configuration similar to core bar 240 (FIG. 16) can be used in lieu of core bars 120 in the mold 50 (FIGS. 5-8). Prior to removing the uncured blocks 10 from the mold 50, the core bars can be removed from the mold via openings 130 to form horizontally extending recessed portions having roughened surfaces on the block faces.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. An apparatus for molding and forming a roughened surface texture on at least one surface of an uncured masonry block, comprising:
a mold defining at least one mold cavity, a first opening through which block-forming material is introduced into the mold cavity, and a second opening through which a formed, uncured block may be removed from the mold cavity;
wherein the mold further comprises at least one wall having a plurality of projections extending into the mold cavity and contacting an adjacent surface of the uncured block, such that when the uncured block is removed from the mold cavity, the projections create a roughened surface texture on at least two surface portions of the adjacent surface, the at least two surface portions being separated by a recessed surface portion in the adjacent surface to give the appearance of two separate block faces in the adjacent surface.

2. The apparatus of claim 1, wherein the recessed surface portion extends horizontally of the uncured block so that the two roughened surface portions are formed one above the other in the adjacent surface of the uncured block.

3. The apparatus of claim 1, wherein the recessed surface portion extends vertically of the uncured block so that the two roughened surface portions are formed side-by-side in the adjacent surface of the uncured block.

4. The apparatus of claim 1, wherein the projections are configured to create a roughened surface texture on at least three surface portions of the adjacent surface of the uncured block as it is removed from the mold cavity, the at least three roughened surface portions being separated by the recessed surface portion and another recessed surface portion that intersect each other to give the appearance of three separate block faces in the adjacent surface.

5. The apparatus of claim 1, wherein the mold comprises an elongated bar projecting into the mold cavity from the at least one wall and contacting the adjacent surface of the uncured block to form the recessed surface portion, and the projections comprise first and second sets of projections separated by the elongated bar, each of the first and second sets of projections contacting and creating a roughened surface texture on one of said surface portions as the uncured block is removed from the mold cavity.

6. The apparatus of claim 5, wherein the elongated bar is a vertical bar elongated in a direction extending between the first and second openings of the mold cavity.

7. The apparatus of claim 5, wherein the elongated bar is elongated in a direction extending between opposite side walls of the mold, the elongated bar being adapted to be removed from the mold cavity through an opening in one of said opposite side walls prior to removing the uncured block from the mold.

8. The apparatus of claim 7, wherein the first set of projections is positioned above the second set of projections, the projections of the first set extending into the mold cavity a greater distance than the projections of the second set such that when the uncured block is removed from the mold cavity, the projections of the second set move past but cannot contact the recessed surface portion.

9. The apparatus of claim 1, wherein the projections taper in a direction extending into the mold cavity.

10. The apparatus of claim 9, wherein the projections are generally pyramidal or frusto-pyramidal in shape.

11. The apparatus of claim 1, wherein the projections are positioned side-by-side in multiple rows of projections, each projection having a respective base that adjoins a base of an adjacent projection in the same row, the rows of projections extending diagonally across the at least one wall of the mold so as to define diagonally extending grooves between adjacent rows of projections.

12. The apparatus of claim 5, wherein the bar comprises a plurality of projections that are configured to create a roughened surface texture on the recessed surface portion as the bar is moved relative to the uncured block.

13. The apparatus of claim 1, further comprising at least one removable core bar extending into the mold and having a plurality of projections that are configured to create a roughened surface texture on a surface of the uncured block contacting the projections on the core bar as the core bar is moved across the surface of the uncured block.

14. The apparatus of claim 12, wherein the core bar extends vertically into the mold to form a vertically extending recessed portion or core in the uncured block.

15. The apparatus of claim 12, wherein the core bar extends horizontally into the mold to form a horizontally extending recessed portion or core in the uncured block.

16. An apparatus for molding and forming a roughened surface texture on at least one surface of an uncured masonry block, comprising:
a mold defining at least one mold cavity, in which an uncured block can be formed, the mold having an inner surface that forms an elongated notch in at least one surface of the uncured block to define first and second surface portions on opposite sides of the notch, the inner surface comprising a plurality of block-texturing members that form a roughened surface texture on the first and second surface portions when the block-texturing members are moved across the first and second surface portions upon removal of the uncured block from the mold.

17. The apparatus of claim 16, wherein the plurality of block-texturing members are arranged in rows of block-texturing members, the rows comprising a first set of rows positioned above a second set of rows, wherein the block-texturing members of the first set of rows contact the first surface portion of the uncured block and the block-texturing members of the second set of rows contact the second surface portion of the uncured block, and the block-texturing members of the first set of rows extend into the mold a greater distance than the block-texturing members of the second set of rows.

18. The apparatus of claim 17, further comprising a core bar that is adapted to form the notch in the at least one surface of the uncured block, the core bar being slidably received between the first and second rows of projections and being removable from the mold through a side wall of the mold.

19. A method for forming a masonry block, comprising:
introducing block-forming material into a mold cavity of a mold, the mold having a plurality of projections extending into the mold cavity and located between the top and bottom of the mold cavity;
forming an uncured block in the mold cavity, the uncured block having at least one surface on which there is formed at least one elongated recessed surface portion separating the at least one surface into first and second surface portions; and
removing the uncured block from the mold cavity to move the projections across the at least one surface of the uncured block to produce a roughened texture on the first and second surface portions so as to give the appearance of two split block faces on the at least one surface of the uncured block.

20. The method of claim 19, wherein:
forming an uncured block in the mold cavity comprises forming at least first and second elongated recessed surface portions in the at least one surface of the uncured block, the first and second recessed surface portions intersecting each other to define first, second, and third surface portions separated by the recessed surface portions; and
removing the uncured block from the mold cavity to move the projections across the at least one surface of the uncured block produces a roughened texture on the first, second, and third surface portions so as to give the appearance of three split block faces on the at least one surface of the uncured block.

21. The method of claim 19, wherein the projections move relative to the uncured block in a direction parallel to the at least one surface of the uncured block as it is removed from the mold.

22. The method of claim 19, wherein the at least one recessed surface portion is formed by a core bar extending into the mold.

23. The method of claim 22, wherein the mold is moved in a first direction relative to the uncured block when removing the uncured block from the mold, and prior to removing the uncured block from the mold, the core bar is removed from the mold in a second direction that is non-parallel to the first direction.

24. The method of claim 19, further comprising forming a roughened surface texture on the recessed surface portion of the uncured block.

25. A method for forming a masonry block using a mold comprising a plurality of walls, a first opening, and a second opening opposite the first opening, the method comprising:
introducing block-forming material into the mold via the first opening to form an uncured block having at least one surface on which there is formed at least one elongated notch separating the at least one surface into first and second surface portions; and
removing the uncured block from the mold through the second opening, wherein the act of removing the uncured block from the mold creates a roughened texture on the first and second surface portions to provide the appearance of two separate split block faces on the at least one surface of the uncured block.

26. The method of claim 25, wherein the notch is formed by a core bar that is removed through an opening in a side wall of the mold prior to removing the uncured block from the mold.

27. The method of claim 25, wherein a notch is formed on at least a first surface and a second, opposing surface of the uncured block, each of the first and second surfaces having first and second surface portions separated by a respective notch, and removing the uncured block from the mold creates a roughened surface texture on the first and second surface portions of the first and second surfaces.

28. The method of claim 25, wherein the uncured block in the mold is formed with notches at opposite side edges of the at least one surface extending the height of the uncured block.

29. A method for forming a masonry block, comprising:
placing a core bar in a mold, the core bar having a plurality of projections formed thereon;
forming an uncured block in a mold; and
moving the core bar relative to the uncured block to create a roughened surface texture on a surface portion of the uncured block contacting the projections of the core bar.

30. The method of claim 29, wherein moving the core bar relative to the uncured block comprises removing the uncured block from the mold, which causes the core bar to move relative to the uncured block.

31. The method of claim 30, wherein the core bar forms a core in the uncured block, and-the method further comprises curing the uncured block after it is removed from the mold and splitting the cured block in an imaginary plane extending through the core in a direction parallel to the length of the core to form first and second smaller blocks, each having a notch formed in one surface thereof at the location of the core.

32. The method of claim 29, wherein moving the core bar relative to the uncured block comprises removing the core bar from the mold in a first direction, and the method further comprises removing the uncured block from the mold in a second direction that is non-perpendicular to the first direction.

33. A core bar comprising an elongated body having plurality of projections configured to create a roughened surface texture on a surface of an uncured masonry block as the projections are moved across the surface of the uncured block.

34. The core bar of claim 33, wherein the projections comprise frusto-pyramids or portions thereof.
